(19) United States
(12) Patent Application Publication
(10) Pub. No.: US 2002/0129794 A1
(43) Pub. Date: Sep. 19, 2002

(54) Curved fuel injector nozzle orifice

(76) Inventors: Jun Xin, Powell, OH (US); Michio Kawamoto, Powell, OH (US); Yoshio Maeda, Dublin, OH (US); Stephen Shih, Marysville, OH (US); Edwin Itano, Hilliard, OH (US)

Correspondence Address: RANKIN, HILL, PORTER & CLARK LLP, 700 HUNTINGTON BUILDING, 925 EUCLID AVENUE, CLEVELAND, OH, 44115-1405, US

(21) Appl. No.: 09/812,203

(22) Filed: Mar. 19, 2001

(51) Int. Cl. F02M 1/00; F02M 61/00

(52) U.S. Cl. 123/470; 239/533.12

(57) ABSTRACT

A fuel injection system including an inlet port, a valve for closing and opening the inlet port, and a fuel injector. The fuel injector is disposed in an inlet passage that communicates with the port and is operable to supply fuel to the combustion chamber when the valve is open. The fuel injector has an orifice that is designed to provide a fuel spray that is shaped as a peripheral portion of an ellipse.

### BACKGROUND OF THE INVENTION

1. Field of the Invention

The present invention generally relates to fuel injection systems and, more particularly, to fuel injection systems having specially designed and targeted injectors to improve delivery of fuel to the combustion chamber.

2. Description of Related Art

Conventional fuel injectors are placed in the air inlet passageway relatively behind the inlet valve. The inlet valve protects the fuel injector from the combustion process. At the appropriate time in the engine cycle the inlet valve opens and a predetermined charge of fuel is emitted from the injector. Typically, the nozzle orifice of the fuel injector is circular, and emits a rather cone-shaped spray of fuel. The fuel enters the combustion cylinder, but a certain portion of the fuel lands upon the valve, the valve stem, and the air inlet passageway. Due to the residual heat of combustion, fuel that lands on these surfaces evaporates, and eventually enters the combustion chamber. This results in imprecise quantities of fuel being provided to the combustion chamber, and may cause ignition and efficiency problems. Moreover, the fuel coating may create a residue or carbon build up on the valves and passageway, which will eventually lead to further inefficiencies.

Therefore, there exists a need in the art for a fuel injector that will eliminate or reduce the undesired spraying of fuel from the injectors. There further exists a need in the art for an improved fuel injector orifice that will increase efficiency and effectiveness of the fuel injector system.

### SUMMARY OF THE INVENTION

The present invention is directed toward a fuel injector that reduces or eliminates the problems in the art. The present invention is further directed toward a spray nozzle orifice that directs a spray of fuel into the cylinder substantially without impinging the fuel on the inlet valve.

In accordance with the present invention a fuel injection system includes an inlet port, a valve, and a fuel injector. The inlet port communicates with an inlet passage. The valve includes a valve stem that extends through the inlet passage and is operable to open and close the inlet port. The valve is sealed against a valve seat to close the inlet port and is opened to define a gap between the valve and the valve seat. The fuel injector is disposed in the inlet passage and is generally directed toward the port. The fuel injector is adapted to supply a spray of fuel through the gap when the valve is opened. The injector has an orifice through which fuel flows, and the orifice is adapted to provide a spray that is shaped as a peripheral portion of an ellipse, the spray being directed toward and adapted to flow through the gap.

In further accordance with the present invention, the fuel injector provides a pair of fuel sprays. The fuel sprays may supply a single combustion chamber with fuel via one port or via two ports.

In further accordance with the present invention, the fuel injector orifice is provided by an array of circular openings. Alternatively, the orifice is provided by an elongated arcuate opening or a combination of circular/non-circular openings and an elongated arcuate opening.

### BRIEF DESCRIPTION OF THE DRAWINGS

These and further features of the invention will be apparent with reference to the following description and drawings, wherein:

FIG. 1 is a schematic drawing showing a fuel injector system according to the present invention;

FIG. 2 is a schematic drawing showing a further fuel injector system according to the present invention;

FIGS. 3A-3C diagrammatically illustrate a fuel spray pattern using a fuel injector according to the present invention;

FIGS. 4A-4H diagrammatically illustrate further spray patterns using a fuel injector according to the present invention, such spray patterns being useful for supplying a pair of fuel sprays;

FIG. 5 schematically illustrates an injector orifice according to the present invention;

FIG. 6 schematically illustrates a further injector orifice according to the present invention;

FIG. 7 schematically illustrates a spray pattern with the present invention using two injectors to supply fuel to two ports;

FIG. 8 schematically illustrates a spray pattern with the present invention using a single injector to supply fuel to two ports; and,

FIG. 9A schematically illustrates a spray pattern having non-uniform spray penetration; and,

FIG. 9B-9D schematically illustrates how a non-uniform spray pattern can be used to provide a non-uniform spray penetration.

### DETAILED DESCRIPTION OF THE PREFERRED EMBODIMENTS

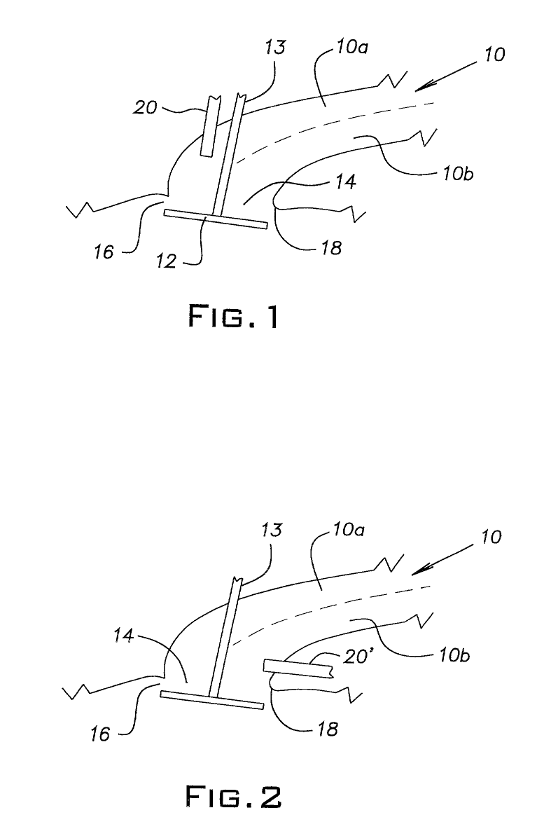

With reference to the FIGS. 1 and 2, a fuel injector according to the present invention is disposed in an inlet passage 10 relatively upstream of the inlet valve 12 and associated inlet port 14. The valve 12 has a first side facing the combustion chamber and a second side facing the inlet passage 10. The valve 12 is opened/closed by a valve actuation mechanism (not shown) that engages the valve stem 13 so that air and fuel are communicated to the combustion chamber via the inlet port 14 at an appropriate time during the engine cycle, as is well known in the art. When opened, an annular gap 16 is formed between the valve 10 and the valve seat 18 through which air and fuel may flow.

FIG. 1 shows the situation wherein the fuel injector 20 is disposed in the upper half 10a of the inlet passage 10 and FIG. 2 shows the situation wherein the fuel injector 20′ is disposed in the lower half 10b of the inlet passage. Although the injectors 20, 20′ are positioned at different locations, their general structure, as well as the structure and orientation of the injector orifices, is generally identical. However, and as will be apparent from the following discussion, the relative position of the fuel injector 20, 20′ in the inlet passage 10 affects the targeting of the fuel spray emitted from the injector.

The inventors have found that restricting the fuel injector spray to a predetermined pattern is desirable as it eliminates or reduces many of the problems in the art discussed hereinbefore. The spray pattern experienced at the inlet port is affected by many factors, such as the distance between the injector 20, 20′ and the port 14, the injector pressure, the injector orifice configuration, the engine operating conditions, etc. Therefore, although the injector orifice and injector spacing are described hereinafter with specificity, the exact operating parameters of the injectors, the dimensions of the injector orifice, and the orientation of the injector relative to the inlet port will have to be determined and tuned for each engine incorporating the present invention.

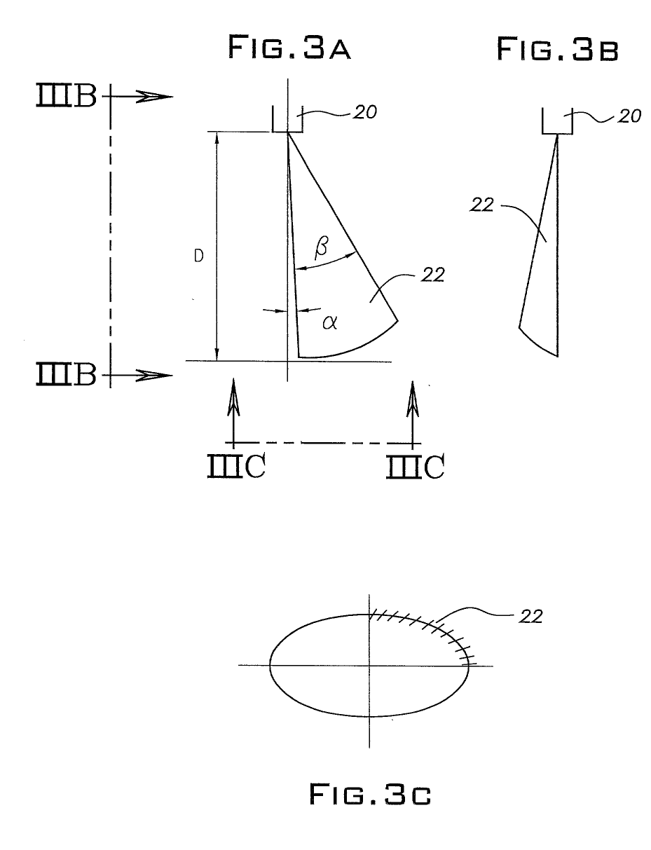

With reference to FIGS. 3A-3C, a fuel injector 20, 20′ and associated spray pattern 22 according to the claimed invention is disclosed. The injector orifice is designed such that the spray 22 therefrom is confined in a particular pattern. As shown, the illustrated spray issues from the injector in a part-elliptical pattern having a spread angle β and an angle to vertical (i.e., the axis of the injector) α. Preferably, β is between about 20° and 30° and most preferably is about 24° and α is between about 1° and 6° and most preferably about 3°. Naturally, the values for β and α will be specifically chosen to correspond with the valve port size (gap between valve 12 and valve seat 16) and the distance D of the injector 20, 20′ from the inlet port 14, so these values may change without departing from the scope of the present invention.

As shown best in FIG. 3C, the spray pattern 22 provided by the injector 20, 20′ generally conforms with the perimeter of an ellipse, and covers only the upper right quadrant of the ellipse perimeter. As will be apparent from the following description, this spray pattern prevents or precludes spraying of fuel onto the valve stem 13 or other areas in the inlet passageway 10 where fuel is not desired. Naturally, the spray pattern may be varied to cover a different quadrant of the ellipse, or to bridge ellipse quadrants without departing from the invention defined herein.

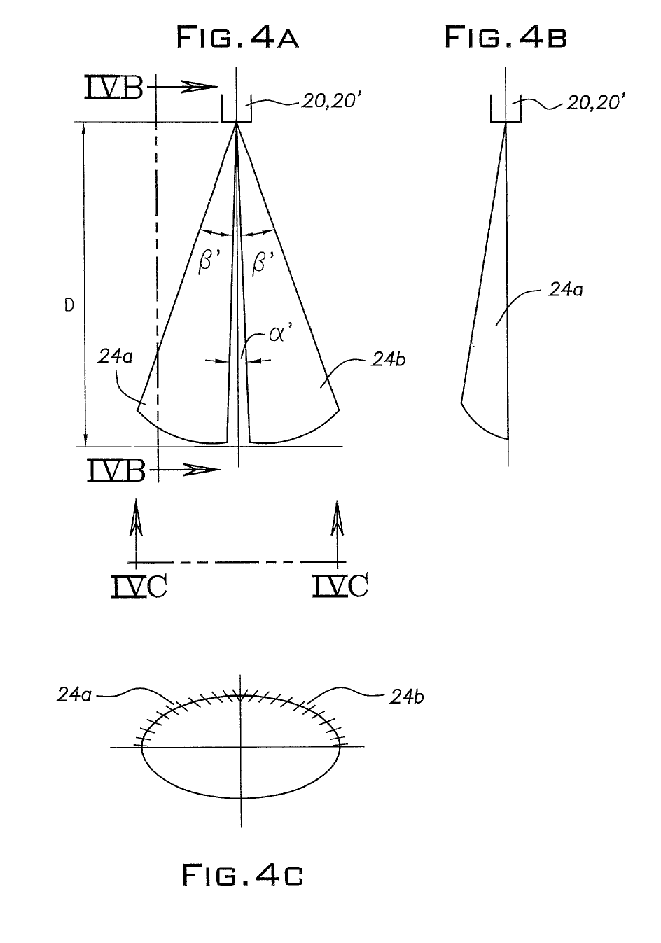

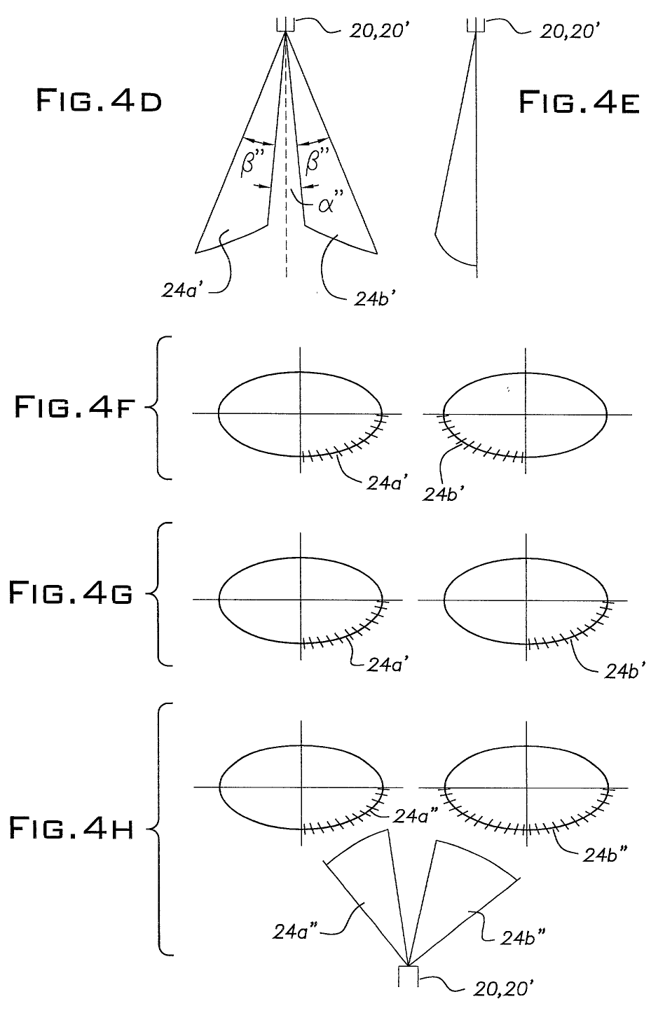

FIGS. 4A-4C schematically illustrate a related fuel injector 20, 20′ and associated spray pattern 24a, 24b, which are intended to supply a pair of fuel sprays. Such fuel sprays may be used for one inlet port so that maximum spray dispersion is achieved. As shown, the illustrated spray issues from the injector in a part-elliptical pattern, each spray having a spread angle β′ and there being a spacing angle α′ between the sprays. In the illustrated embodiment, β′ is preferably between about 25° and 35° and most preferably about 30° and α′ is preferably between about 4° and 12° and most preferably about 8°. Naturally, the spray pattern may be varied to cover different quadrants of the ellipse, or to bridge ellipse quadrants without departing from the invention defined herein.

As shown best in FIG. 4C, the spray pattern provided by the injector generally conforms with the perimeter of an ellipse, and covers most of the upper right and upper left quadrants of the ellipse perimeter. As will be apparent from the following description, this spray pattern reduces or prevents spraying of fuel onto the valve stem or other areas in the inlet passageway where fuel is not desired.

FIGS. 4D-4G schematically illustrate a related fuel injector 20, 20′ and associated spray patterns 24a′, 24b′, which are intended to supply a pair of fuel sprays. Such fuel sprays may be used to supply a cylinder having a pair of inlet valves. The injector orifice is designed such that the sprays therefrom are confined in a particular pattern. As shown, the illustrated spray issues from the injector in a part-elliptical pattern, each spray having a spread angle β″ and there being a spacing angle α″ between the sprays. n the illustrated embodiment, β″ is preferably between about 25° and 35° and most preferably about 30° and α″ is preferably between about 10° and 60°, depending upon the targeting areas for two inlet ports, as illustrated in FIGS. 4F and 4G. FIG. 4H shows yet another alternative for supplying fuel sprays 24a″, 24b″ to a pair of inlet valves.

FIGS. 1, 2, 7 and 8 schematically illustrate positioning and operation of the injector(s). FIG. 7 illustrates operation of a pair of injectors 20, 20′, each associated with a single inlet valve 14. The injectors are essentially identical to that shown in FIGS. 3A-3C, or a combination of FIGS. 3A-3C and FIGS. 4D-4H, described hereinbefore. Similarly, FIG. 8 illustrates operation of a single injector 20, 20′ to supply a pair of fuel sprays 24a, 24b to a pair of ports 14. Accordingly, the injector arrangement illustrated in FIG. 8 is essentially identical to that shown in FIGS. 4A-4H and described hereinbefore.

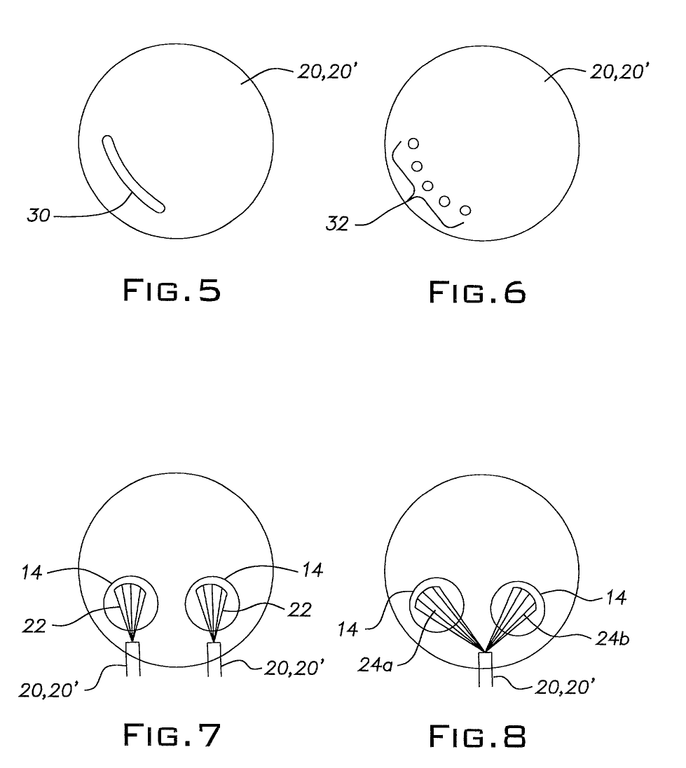

With reference to FIGS. 5 and 6, injector orifices according to the present invention are illustrated. More specifically, FIG. 5 shows a first injector orifice 30 wherein the opening in the injector is generally curved or arcuate and defines a perimeter portion of a circle. Such a first injector orifice will provide a fuel spray pattern that is generally a portion of a perimeter of an ellipse, as shown in FIGS. 3A-3C and discussed hereinbefore. FIG. 6 shows an injector orifice that comprises an array of small circular openings 32 which, when taken collectively, provide a spray pattern that is comparable to that of the curved opening 30 of the orifice of FIG. 5. The circular openings help to ensure atomization of the fuel. The array of circular openings 32 provides the advantage that the opening size can be adjusted to accommodate different spray requirements, such as desired droplet size, non-uniform droplet size, and optimum spray penetration (uniform or non-uniform). It is considered apparent that, for injectors intended to provide a pair of fluid streams, a pair of curved openings 30 or a pair of circular opening arrays 32, or a combination of curved openings and circular arrays would be necessary. Alternatively, the openings may be non-circular, or the array 32 may be a combination of circular and non-circular openings, as desired.

The injector injectors 20, 20′ and orifices 30, 32 of the present invention are also designed and adapted to balance spray quality and injection system requirements to optimize engine performance. For example, with the injector orifice shown in FIG. 6, the opening size is designed such that a resulting average drop size pattern can be realized to achieve long penetration, where necessary. For a uniform spray pattern, relatively small holes and higher spray pressures are desirable. For a more non-uniform spray pattern (i.e., where some of the spray must travel a longer distance), the opening sizes vary such that relatively smaller holes are provided in one area (shorter spray distance), and relatively larger holes are provided to supply a spray to areas requiring further spray penetration. With the non-uniform spray pattern, relatively lower spray pressures may be used.

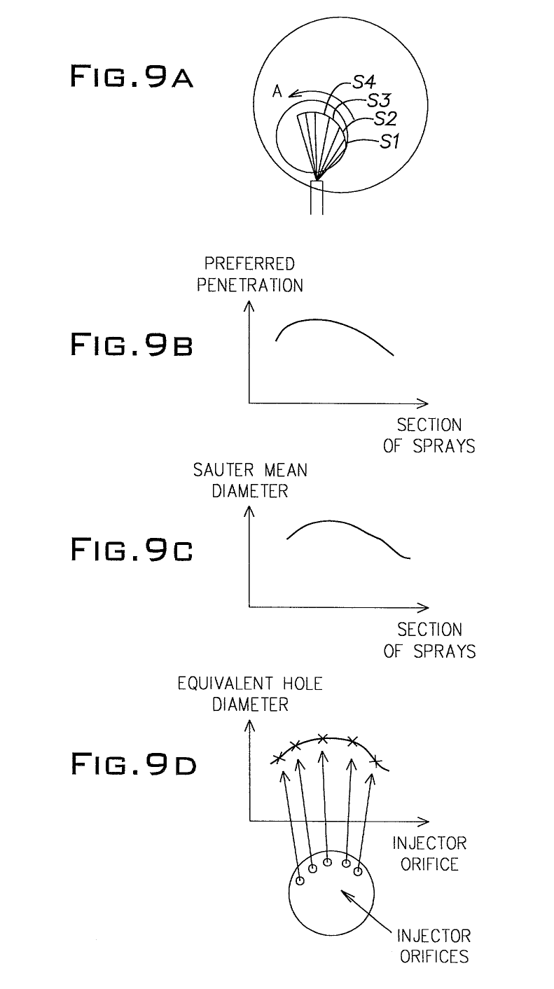

For example, with reference to FIGS. 9A-9D, one embodiment having non-uniform spray pattern is illustrated. The penetration of the spray sections S1-S4 are different from one another because the distances from the injector to the inlet gap vary in the azimuthal direction A. For uniform sprays under open-valve injection conditions, if droplet sizes are relatively small, too much fuel enters the cylinder through a small part of the inlet gap ring because small fuel droplets are more likely to deviate from the nominal spray targeting direction due to the influence of inlet flows. If droplet sizes are relatively big, evaporation and mixing will deteriorate because large droplets take a longer time to vaporize, and impinge upon walls in some sections where shorter penetrations (therefore smaller droplet sizes) are desired. FIGS. 9B-9D show how nonuniform spray patterns are used to accommodate non-uniform penetration requirements. These figures illustrate the relationship between the spray pattern and orifice size and how a nonuniform spray penetration pattern is provided by varying the injector orifice sizes.

With reference to FIGS. 1 and 2, the preferred injection timing and injection targeting directions will be discussed. First, with reference to FIG. 1, it is noted that if the injector 20 is disposed in the upper half 10a of the inlet passageway 10, the injector 20 is targeted or aimed slightly toward the back of the inlet valve 12 and preferably on a side such that the valve stem 13 does not interfere with the spray. On the other hand, and with reference to FIG. 2, if the injector 20 is disposed on the lower half 10b of the inlet passageway 10, the injector 20′ is targeted or aimed at the sidewall of the passageway 10 relatively above the inlet port 14. In either case, the port timing is such that the valve 12 is opened slightly ahead of injection of fuel from the injectors 20, 20′. The fuel, aimed as set forth hereinbefore, is entrained in the air flow and redirected through the gap 16 between the valve 12 and the valve seat 18, and thus through the port 14 into the combustion chamber.

The present invention has been described herein with particularity, but it is noted that the scope of the invention is not limited thereto. Rather, the present invention is considered to be possible of numerous modifications, alterations, and combinations of parts and, therefore, is only defined by the claims appended hereto.

What is claimed is:

1. A fuel injection system comprising:
an inlet port that communicates with an inlet passage;
a valve for opening and closing said inlet port, said valve having a valve stem that extends through said inlet passage, said valve being closed against a valve seat to seal said inlet port and being opened to define a gap between said valve and the valve seat;
a fuel injector disposed within said inlet passage and generally directed toward said port, said fuel injector being adapted to supply a spray of fuel through said gap when said valve is opened, said injector having at least one orifice through which fuel flows, said at least one orifice being adapted to provide a spray that is shaped as a peripheral portion of an ellipse, said spray being directed toward and adapted to flow through the gap.

2. The fuel injection system according to claim 1, wherein said fuel injector provides a pair of fuel sprays.

3. The fuel injection system according to claim 2, wherein said pair of sprays are generally identical.

4. The fuel injection system according to claim 2, wherein said pair of sprays are different from one another.

5. The fuel injection system according to claim 3, wherein the injector orifice has an array of openings selected from the group consisting of circular openings and non-circular openings.

6. The fuel injection system according to claim 3, wherein the injector orifice includes an opening that is elongated and curved and defines a portion of a circle.

7. The fuel injection system according to claim 5, wherein the injector orifice includes an opening that is elongated and curved and defines a portion of a circle.

8. The fuel injection system according to claim 1, wherein the injector orifice has an array of openings selected from the group consisting of circular openings and non-circular openings.

9. The fuel injection system according to claim 1, wherein the injector orifice includes an opening that is elongated and curved and defines a portion of a circle.

10. The fuel injection system according to claim 1, wherein said passage has an upper half and a lower half, and said injector is disposed in the upper half of said passage.

11. The fuel injection system according to claim 10, wherein said fuel injector provides a pair of fuel sprays.

12. The fuel injection system according to claim 11, wherein the injector orifice has an array of openings selected from the group consisting of circular openings and non-circular openings.

13. The fuel injection system according to claim 11, wherein the injector orifice includes an opening that is elongated and curved and defines a portion of a circle.

14. The fuel injection system according to claim 1, wherein said passage has an upper half and a lower half, and said injector is disposed in the lower half of said passage.

15. The fuel injection system according to claim 14, wherein said orifice is selected from the group consisting of an array of circular openings and an elongated opening that defines a portion of a circle.

16. The fuel injection system according to claim 14, wherein said fuel injector provides a pair of fuel sprays.

17. The fuel injection system according to claim 16, wherein the injector orifice has an array of openings selected from the group consisting of circular openings and non-circular openings.

18. The fuel injection system according to claim 16, wherein the injector orifice includes an opening that is elongated and curved and defines a portion of a circle.

19. The fuel injection system according to claim 14, wherein said orifice is selected from the group consisting of an array of non-circular openings and an elongated opening that defines a portion of a circle.

20. The fuel injection system according to claim 14, wherein said orifice is selected from the group consisting of an array of circular and non-circular openings and an elongated opening that defines a portion of a circle.
